(19) United States
(12) Patent Application Publication
(10) Pub. No.: US 2022/0327476 A1
(43) Pub. Date: Oct. 13, 2022

(54) Automated System for Payload Condition Monitoring and Prediction Using Digital Twins

(71) Applicants: Saravan Kumar Shanmugavelayudam, Stillwater, OK (US); Arif Rahman, Stillwater, OK (US); Trung Nguyen, Stillwater, OK (US); Balaji Jayakumar, Stillwater, OK (US); Shoaib Shaikh, Stillwater, OK (US)

(72) Inventors: Saravan Kumar Shanmugavelayudam, Stillwater, OK (US); Arif Rahman, Stillwater, OK (US); Trung Nguyen, Stillwater, OK (US); Balaji Jayakumar, Stillwater, OK (US); Shoaib Shaikh, Stillwater, OK (US)

(21) Appl. No.: 17/716,439

(22) Filed: Apr. 8, 2022

Related U.S. Application Data
(60) Provisional application No. 63/172,612, filed on Apr. 8, 2021.

(51) Int. Cl. G06Q 10/08

(52) U.S. Cl. CPC G06Q 10/0833; G06Q 10/0832; G06Q 10/08355

(57) ABSTRACT

A system and method implemented on a computing device which tracks a condition of a payload and a container conveying the payload in shipment by a tracking module which receives signals from one or more sensors. The monitoring data is transmitted to a remote server which communicates in real-time, calculates a current condition or state of the payload and container, and which predicts one or more future conditions or states of the payload and container based on an expected environmental, operational and handling conditions. The predicted future condition is compared to estimated time of shipment completion and one or more prescribed condition thresholds corresponding to the type of the payload, container type and the shipping route. Responsive to predicting an impending violation of a payload handling condition, an intervention decision is made, and one or more notifications with optional digital preventive action procedures are transmitted to corresponding users.

### FIELD OF THE INVENTION

This patent application claims benefit of the filing date of U.S. Provisional Patent Application 63/172,612, Applicant's Agent's docket FGPMXQ21AP, filed on Apr. 8, 2021, by Saravan Kumar Shanmugavelayudam, et al. The invention generally relates to shipping, storage or transport container and payload condition monitoring, future condition predicting, reporting, and automated actions to prevent a shipping or storage container with a perishable payload from exceeding predetermined prescribed conditions, especially for transportation of perishable materials such as blood, vaccines, tissue, organs, biologics, pharmaceuticals, specimens, foods, chemicals, reagents, electronics, sensors and a wide range of temperature sensitive materials. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF INVENTION

Blood, vaccines and other temperature sensitive biologics must go through a series of steps from manufacturing or collection to distribution to patient. This is known as the “cold chain”, which may be defined as a temperature-controlled supply chain. At each step in the cold chain, precise temperatures must be maintained to ensure the integrity and efficacy of the products. If the blood or blood product (e.g., component) is allowed to become too cold or too warm, then the blood products may become unusable. Other perishable products, such as tissues, organs, biological samples, vaccines, cell and gene therapy products, blood diagnostic specimens, fresh produce, food and food components, and certain chemicals share similar requirements to maintain temperature within a certain range during storage and transport.

Blood banks, hospitals, and biopharmaceutical manufacturers ship temperature sensitive biologics in insulated shipping containers designed to maintain products within the required temperature range. Most of these biologics lose efficacy if they spend time outside the required temperature range. Depending on the type of insulation material, amount of coolant, phase change temperature of the coolant, operational and ambient conditions, these shipping containers protect the product without temperature excursion to varying durations. As a standard practice, stakeholders in these industries test the insulated shipping container against different ambient conditions in a lab setting before authorizing the use of the container to transport a specific product. Lab testing procedures assume ideal (conventional) conditions, are not comprehensive, and are deficient in considering real-world conditions. When encountering an extreme ambient condition or processing parameters (such as a flight or delivery delay), these shippers tend to fail, sending the products outside the required temperature range. This results in significant product loss and poses a huge patient safety risk.

### SUMMARY OF THE EXEMPLARY EMBODIMENTS OF THE INVENTION

A system and method implemented on a computing device tracks a condition of a payload and a container conveying the payload in shipment by a tracking module which receives signals from one or more sensors. The monitoring data is transmitted to a remote server which communicates, in real-time, calculates a current condition or state of the payload and container, and which predicts one or more future conditions or states of the payload and container based on an expected environmental, operational and handling conditions. The predicted future condition is compared to estimated time of shipment completion and one or more prescribed condition thresholds corresponding to the type of the payload, container type and the shipping route. Responsive to predicting an impending violation of a payload handling condition, an intervention decision is made, and one or more notifications with optional digital preventive action procedures are transmitted to corresponding users.

### BRIEF DESCRIPTION OF THE DRAWINGS

The figures presented herein, when considered in light of this description, form a complete disclosure of one or more embodiments of the invention, wherein like reference numbers in the figures represent similar or same elements or steps.

FIG. 1 sets forth an example of a system architecture according to the present invention.

FIG. 2 illustrates at least three shipping container sensor configurations according to various embodiments of the invention.

FIG. 3 shows one possible embodiment according to the present invention of a logical process executed by a computer processor to perform future state prediction for a shipment in transit or preparing for transit.

FIG. 4 illustrates a User interface presentation of Thermal Life (current state) and Performance predictor (future state) information to a user.

FIG. 5 depicts an example preventive action look up table for a refrigerated biologics shipment for a specific shipping lane or route.

### DETAILED DESCRIPTION OF ONE OR MORE EXEMPLARY EMBODIMENT(S) OF THE INVENTION

The present inventors have recognized a problem not yet recognized and/or solved in the cold chain logistics industry. Some containers carrying perishable payloads may have temperature monitors or data loggers which record the temperature inside the payload volume. Typically, the data loggers are retrieved manually at the end of the shipment and the downloaded data is used to determine viability of the product that was shipped. The present inventors have recognized that a key challenge with this methodology is that the data and insights about product viability are only available after shipment completion, and such post-shipment analyses are prone to significant user errors. Even the data loggers that are equipped with standard GSM communication modules to transmit temperature data to a remote server at regular intervals, which is then accessed through a web application, are not capable of offering real-time insights about the condition or state of the shipment. Hence, the present inventors have recognized that there is no means for predicting the future state of a shipment in real-time, and therefore, no technological capability to develop or execute any preventive actions that could safeguard the payload from an impending temperature or other condition excursion or to protect the intended recipient from receiving a damaged payload.

System Overview. Embodiments of the present invention track one or more conditions of a payload and the container in which it is being conveyed by an electronic tracking module which receives signals from one or more condition sensors. The collected condition data is periodically or continuously transmitted to a remote server which comprises of modules capable of processing the received data, in real-time; calculate current condition or state of the payload and container, predict a future condition or state of the payload and container based on the expected environmental, operational and handling conditions. A resulting future condition is compared to estimated time of shipment completion and memory-stored (prescribed) condition thresholds corresponding to the payload type, container type and the shipping route; and, responsive to the comparison indicating an impending violation of a payload handling condition, decide whether an intervention is required, send notifications and digital preventive action procedures to corresponding stakeholders.

Example Embodiments. Various embodiments according to the present invention provide a system comprising of a set of modules and methods to assess the condition or state of a protective packaging container or product inside the container in real-time, and to predict the future state based on forecasted conditions along the shipping route. This enables execution of one or more preventive actions, such as but not limited to, re-routing of the shipment, replacing coolants inside the temperature controlled container, conditioning or charging the container, repackaging the product inside a new container, and dispatching a replacement shipment.

Real-time Visibility, Data Collection, and Input to the Modeler. At least one embodiment according to the present invention engages with a variety of shipping containers commonly referred to as intelligent or smart protective packaging systems. Protective packaging includes the family of packaging systems capable of maintaining the integrity of the product during shipping against environmental and operational variables such as temperature, humidity, pressure, physical shock and light. The protective packaging may also be referred to as a shipping container, active temperature-controlled container, packaging container, protective packaging, container, or shipper. These containers are embedded with one or more condition sensors capable of accurately measuring environmental variables such as temperature, humidity, pressure, light, etc., one or more geospatial location tracking systems such as GPS, cellular triangulation, etc., and one or more communication modes such as Bluetooth, WiFi, ZigBee, NB-IoT, Lora WAN, GSM, etc. Data from these packaging systems are transmitted either to a remote cloud server directly or through a network of gateways positioned globally.

As an example, products that need to be transported within a specific temperature range require protective packaging in the form of an insulated shipping container containing a cooling energy source; such as a Styrofoam container packed with passive cooling materials like wet ice, dry ice or conditioned phase change coolants, also known as passive temperature controlled container; or Vacuum insulated container equipped with powered refrigeration cycle system like Peltier, Stirling engine, also known as active temperature controlled containers. Using on-board sensors, the embedded monitor transmits location, temperature inside the container and/or ambient temperature to the remote cloud server. In at least one embodiment of the present invention, a web service or a distributed string (block chain) is provided that runs on the remote cloud server and analyzes the data stream from the containers in real-time and provides actionable intelligence to all stakeholders.

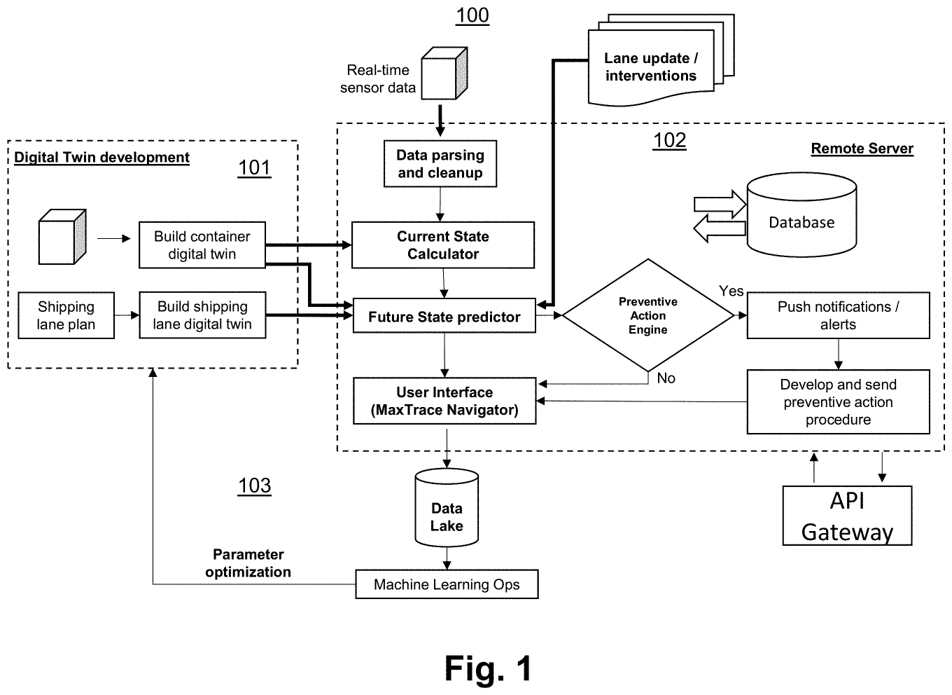

Remote Cloud Server. In the example embodiment 100 of FIG. 1, the remote cloud server 102 comprises a Digital Twin model of the shipping container or protective packaging, wherein the real-time data from the actual container when plugged into the Digital Twin model can calculate current state, predict future state of the packaging, and automatically decide whether a preventive action needs to be triggered. This example embodiment comprises four key modules that automatically convert the real-time sensor data feed from the packaging into a condition or state assessment. The first layer, termed as Digital Twin Development 101, is a stand-alone process to develop a packaging-specific mathematical model or lane-specific model that accurately represents both elements and dynamics of the physical system. The Digital Twin model can be programmed into the remote server.

The second layer, termed as Current State Calculator, runs in the remote server 102 and uses the Digital Twin model to convert the real-time sensor data streamed from the packaging container into its current state.

The third layer, termed as Future State Predictor or Performance Predictor, combines the current state with the expected ambient conditions along the planned transit route to predict the future condition or state of the packaging.

The fourth layer, termed as Preventive Action Engine, compares the future condition or state against pre-determined thresholds and if an impending excursion is predicted then it triggers an automated preventive action. Further, the preventive action engine may develop detailed preventive action procedures automatically, and send them to appropriate stakeholders to prevent a payload condition excursion from happening. The type of preventive actions includes but is not limited to re-routing of shipments, replacement of coolant materials inside an insulated packaging, recharging of shipping systems, and initiating a replacement shipment. These layers may interoperate with adjacent operations engines.

In other embodiments, the second, third and fourth layer may be executed by the embedded tracking device integrated in the shipping container, or at a gateway, or on an edge computing device. The current condition of container or product within the container along with the predicted future condition is presented to stakeholders in the supply chain via a user interface. At the completion of each shipment, all shipment specific data is transferred to a long term storage cloud server which will serve as a Data Lake. The data stored here can further be used in Machine Learning operations 103 to optimize the empirical parameters in the digital twin.

Digital Twin Development. The key elements and dynamics of the protective packaging or the product within the protective packaging, shipping lane or other operational conditions, which affect its condition or state during transit are mathematically correlated to create a digital twin of the protective packaging. The mathematical correlations may comprise of physical or empirical models or both, and may comprise of empirical parameters that are optimized based on experimental observations. The mathematical correlations establish the fundamental relationship between the measured variable (sensor data from the container) and the condition or state of the packaging.

The Digital Twin model is specific to a physical system such as protective packaging, product inside the protective packaging or the shipping lane. In one embodiment, the digital twin is packaging-specific and the mathematical correlations are built using the physical properties of the packaging such as size, thermal energy capacity, insulation rating of the container walls, mass or heat transfer rate through the container, etc. In another embodiment, the digital twin is shipping lane specific and comprises of coordinates of the origin, destination and way point locations, distance traveled, mode of transportation, duration of transport, handling conditions at the way points, etc.

Thermal Packaging Specific Digital Twin Example. An example of one-dimensional correlation representing digital twin of an insulated shipping container, also known as temperature controlled packaging, carrying temperature sensitive product is presented below. The condition or state of this packaging can be defined as the amount of thermal energy that the system has at any given time. Various physical and thermal properties of the packaging are combined to develop a digital heat transfer model capable of determining rate of thermal energy gain or loss from the system as a function of measured temperature from the packaging. Key properties used in building the model includes thermal conductivity of the walls, temperature control system and its energy capacity, size of the container, heat generation sources inside the container, specific and latent heat capacities of the product being transported, emissivity of the container wall, and mass transfer in or out of the container.

Thermal energy Q of a temperature controlled packaging is proportional to the total heat capacity inside the system. When packed and shipped, the packaging system will have a finite amount of thermal energy in the system. As the shipment progresses through a lane, energy is either gained or lost depending on the ambient conditions. For example, in a passive temperature controlled packaging which uses phase change coolants to maintain temperature inside the system, the total latent heat capacity of the coolants is the starting energy state of the packaging container Qᵢ. During transit, if the ambient conditions are warmer than the payload temperature heat continuously tries to enter the system. The thermal insulation in the container walls having thermal conductivity K slows down the rate of heat transfer. Excess heat entering the system is preferentially absorbed by the phase change coolant, which depletes stored latent heat energy to maintain the container and/or the products inside the container within the required temperature range. As time progresses, the phase change coolants use up all the available latent heat energy which leads to product temperature excursion, i.e. product deviating from the required temperature range.

Equations 1 through 3 presents a simplified one-dimensional steady state Digital Twin model, relates the measured ambient and payload temperature inside the shipping container to amount of heat transfer in or out of the container. The rate of heat transfer, in this case, can be further analyzed to calculate the condition or state of the container. If the container has a starting energy state Qᵢ, then the energy remaining Qᵣ at any time step can be calculated by adding or subtracting the amount of heat energy transfer in the container Qₜ:

Qᵢ=m_{E}*L_{f} Eq. 1

Qₜ=Sₚ*(T¿¿amb−T_{pay})¿ Eq. 2

Qᵣ=Qᵢ−Qₜ Eq. 3

where Qᵢ is the initial energy available in the system, m_{E} is the effective weight of the energy source, L_{f} is the latent heat capacity of the energy source, Qₜ is the amount of heat energy entering or leaving the system at any given time, Qᵣ is the amount of energy remaining in the system, Sₚ is shipper dependent parameters for all 3 modes of heat transfer, T_{amb} is the ambient temperature, and T_{pay} is the payload temperature. Equations 1 and 2 may include empirical parameters or correction factors that will help increase accuracy of energy prediction. The digital twin model developed in a stand-alone process is used as a basis for both current state and future state predictions in the remote cloud server.

Current State Calculator. The Current State Calculator is designed to assess the current state or condition of the protective packaging or product inside the packaging by inputting the real-time sensor data from the packaging into the digital twin model. The raw sensor data streamed from the shipping container is passed through a data filter to parse and clean the data string. The data string includes but is not limited to geospatial location coordinates of the packaging, ambient temperature outside the packaging, temperature inside the packaging, intensity of light inside the packaging, altitude, pressure, tilt, vibration, shock, acceleration, relative humidity, sound and other sensory inputs as needed for a particular prescribed state. The calculator inputs the sensor data as needed into the digital twin model for the specific packaging or product within the packaging, and computes the current state or condition.

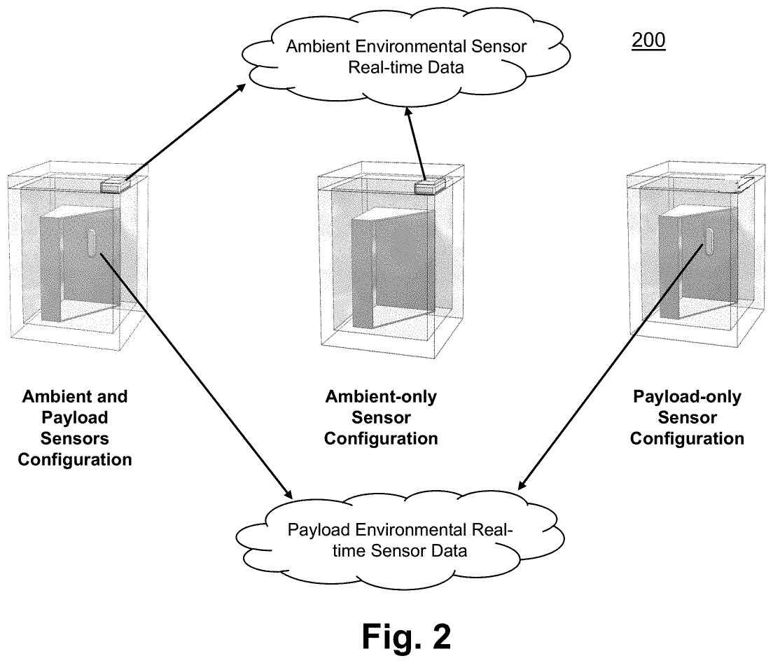

Thermal Packaging Example. In one available embodiment, the Current State Calculator is designed to calculate a thermal energy state of a temperature controlled packaging in real-time. There are at least three shipping container sensor configurations as presented in FIG. 2. The Current State Calculator for assessing thermal energy remaining in an insulated packaging system is specific to each type of packaging system. Environmental sensors are placed both inside and outside of an insulated packaging container along with a GPS or other geo-spatial location tracking system. The sensor inside the packaging provides detailed readings of the actual environment near the product being transported, on the surface, or from the core of a material as needed, while the sensor outside the packaging provides details on the ambient conditions outside the packaging. The data from these sensors along with the package location information from the on-board GPS or other geo-spatial location tracking system is transmitted to the remote server. The Remote Server comprises of the packaging-specific Digital Twin, which in this example are Equations 1-3 as stated above. When the ambient and payload temperatures are processed through Equation 2, the amount of energy leaving or entering the system is calculated. The resulting energy remaining from Equation 3 represents the true state or condition of the packaging. The calculated energy remaining is then stored inside the remote server and passed to the Future State Predictor.

In another available embodiment, one environmental sensor with GPS or other geo-spatial location tracking system and real-time reporting capability is placed inside the packaging. The sensor transmits both package location and payload temperature to the remote server. Through third party data sources accessed via Application Programming Interfaces (API), the location information along with the time stamp is mapped to corresponding ambient weather data (temperature). The ambient temperature from the 3^{rd} party data source and the measured payload temperature will then be passed into the Current State Calculator to estimate the thermal energy remaining in the packaging container. Alternatively, the environmental sensor with GPS and real-time reporting capability may also be placed outside the packaging. The sensor transmits both package location and ambient temperature to the remote server. By assuming a steady state (prescribed condition), the real-time ambient temperature data is used to calculate energy remaining in the packaging.

Future state predictor. The Future State Predictor in some embodiments incorporates the forecasted environmental and operational conditions at any given time along the shipping lane to estimate its impact on the packaging performance, and predict the time at which an excursion could occur. The Future State Predictor is executed by the Remote Cloud Server using both the packaging- and lane-specific Digital Twins. As a shipment progresses, a new data stream is transmitted to the cloud server at regular intervals, the calculated current state of packaging along with lane updates are inputted to the future state predictor. The Future State Predictor compares the lane updates to the planned shipment lane, computes any lane deviation and revises estimated time to delivery (or shipment completion), connects to a third party server to obtain weather forecast for the remaining trip. The weather forecast data when applied to the packaging specific digital twin results in the amount of time remaining before the packaging or product within the packaging will exceed the required condition threshold. The prediction is stored to a Database and propagated into the preventive action engine.

Thermal Packaging Example. In one embodiment, the Future State Predictor is designed to calculate time remaining before the container or the product inside the container could go out of the expected temperature range. The future state model is the inverse of the heat transfer model used in the Current State Calculator. The model takes two specific inputs: Thermal Energy Remaining from the Current State Calculator, and Lane ambient—forecasted weather along the lane or planned route.

Shipping Lane And Weather Forecast. A shipping lane is defined as the designated route in which the packaging is to be or currently being transported. A well-defined shipping lane may include details such as milestones or waypoints along the route, modes of transportation, handling constraints, and/or transit times. A milestone could either be a geographic location like warehouse, airport, etc. or change in custody of the packaging from one stakeholder to the other such as a courier driver dropping off the packaging at a sorting facility, or a sorting facility releasing the packaging to be airlifted to the next facility, or a courier driver dropping of the packaging at the destination facility. A shipping lane may also include details on expected operational conditions such as environmental (temperature) controlled warehouses, transport trucks, etc. Before a shipment is initiated, the remote server is programmed with the planned route or lane along with the milestones (also known as Digital Lane).

The remote server can also be programmed to access the lane details from a third party server through a series of APIs. The lane data sources may be the logistics provider, carrier, shipper, receiver or other similar third party sources. During the course of the shipment, the same API's may be used to obtain real-time updates on completion of a particular milestone or any deviation from the plan.

Similarly, the remote server can ping third party weather servers on-demand and obtain the latest weather forecast for the locations identified along the planned route. By combining the location-specific weather forecasts, a total forecasted weather along the lane is developed. This process is repeated and a newly forecasted lane ambient is obtained every time the packaging container moves to a new milestone along the lane, or at a pre-determined time interval.

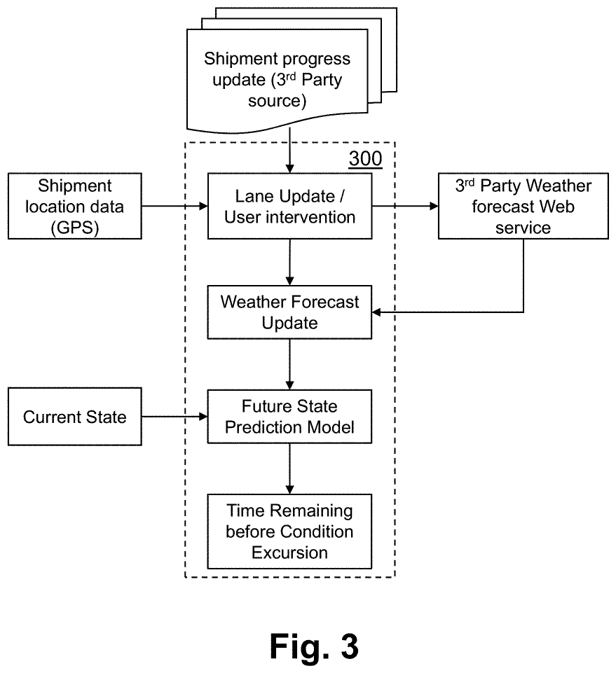

Future State Predictor. The Future State Predictor combines the lane weather forecast and the amount of thermal energy remaining in the system, to calculate the amount of energy needed to maintain the container or the product inside the container at a set temperature point. By comparing thermal energy required for rest of the lane against the total amount of thermal energy remaining in the system, time remaining until temperature excursion is predicted. FIG. 3 shows one possible embodiment 300 according to the present invention of a logical process executed by a computer processor to perform future state prediction for a shipment in transit or preparing for transit.

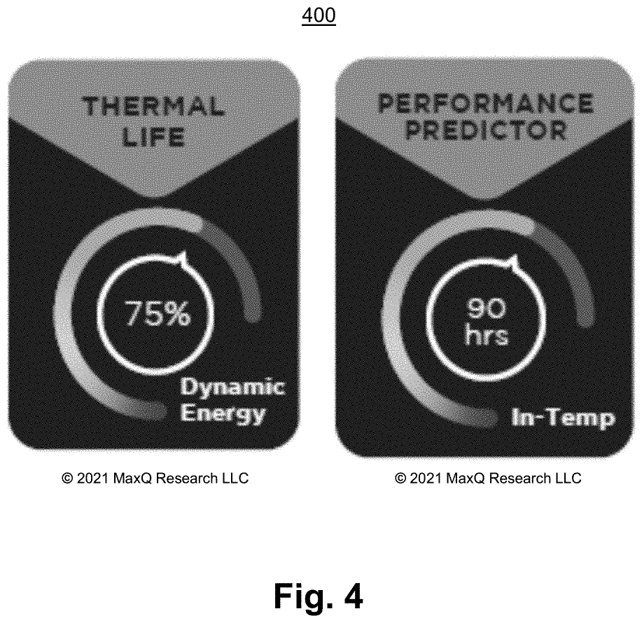

Preventive Action Engine. The current energy state of the shipper along with the predicted time remaining before temperature excursion is presented to the users through a web application. FIG. 4 depicts an example graphical representation of data visualization 400 according to the present invention for display on a computer human interface device via the web application. In this dashboard-like display which is intuitive to understand and interpret, a meter-like icon is shown preferably with a percentage value in the center of the icon indicating predicted remaining thermal life (dynamic energy) and predicted performance of one or more criteria being monitored by the system, such as payload temperature. The depiction of FIG. 4 is shown in black and white per US patent application drawing standards, and which may be suitable for display on certain types of monochromatic user interface devices. For color-enabled user interface devices, common coding may be employed such as using green towards the higher reading portions of the icon (and for the text color in the center of the icon), and red towards the lower reading warning portions of the icon (and for the text color in the center of the icon), with color gradients between red and green such as a yellow portion of the icon midway between highest and lowest reading points.

Alternatively, the energy and time remaining information can also be shared with different stakeholders through API. Further, the remote server is programmed to monitor the current and future state/condition of the container or product within the container, and automatically decide whether an intervention is required. The remote server may be programmed with pre-defined condition thresholds, which when exceeded or predicted to be exceeded, could trigger an automated action. The set of actions include sending a push notification in the form of e-mail, text message, dashboard updating or phone call to appropriate stakeholders indicating of the required intervention to prevent condition excursion. Alternatively, the engine may actively compare the predicted time to an excursion event against the estimated time for shipment completion (delivery) to decide whether an intervention is required. The estimated time for shipment completion could be obtained from 3^{rd} party servers such as logistics providers, freight forwarders and airlines via API.

In addition to notifying an impending excursion, the engine is capable of suggesting appropriate action. Actions may also include transmission of a document with instructions pertaining to the preventive action. These actions could be selected from a pre-stored set of actions in the remote server. Examples of preventive actions include but are not limited to re-routing of the packaging, replacing coolants in a temperature controlled packaging, recharging the container, hibernating a temperature controlled packaging by placing it inside an isothermal storage, and issuing a replacement shipment.

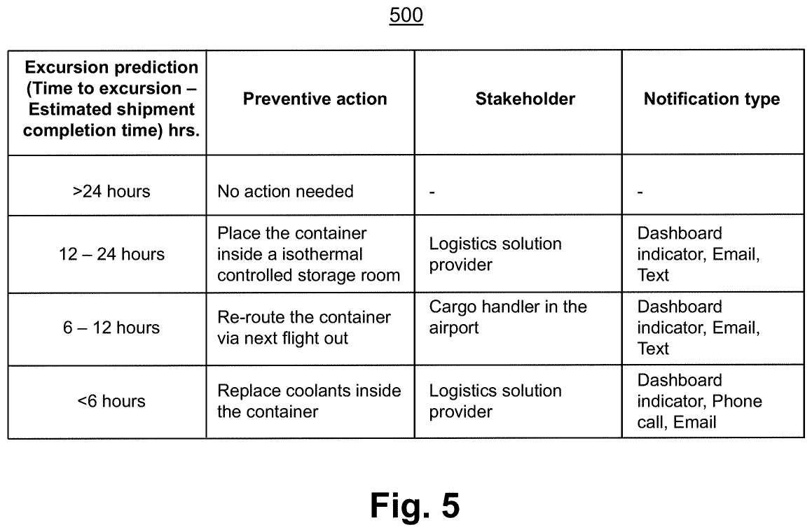

Thermal packaging example. In one embodiment, the preventive action engine may be trained with a set of future state thresholds (time to excursion) and appropriate preventive action. These look up tables are both packaging and lane specific. For example, the table 500 shown in FIG. 5 lists example specific set of thresholds and suggested preventive actions for a shipment carrying specific biological product that needs to be maintained between 2 to 8° C. going from the U.S. to Europe. When the performance predictor estimates the time to temperature excursion, the decision engine compares this against the estimated time for shipment completion. Based on the difference in time, the engine uses the look up table to decide whether and what action should be executed, who should be notified and the preferred mode of notification.

Machine Learning Module. At the completion of each shipment, current and future state calculations are stored in a cloud server, such as a separate server from the remote server handling the real-time processing. This historical information serves as a Data Lake to feed machine learning operations. The Data Lake, in this example embodiment, comprises of actual measured temperatures from the container, location and all other streamed data, along with the calculated current and future state at each time step, and outcome of the preventive action engine. Further, at the shipment completion, the actual condition or state of the container or product within the container is also added to the database. The Data Lake may be incorporated into the Remote Server, or provided through a network connection by another server.

Corresponding Corrective and Preventive Action and the resulting effect on shipment condition are also analyzed. Supervised machine learning models (Recurrent neural network-Long-short term memory model) are trained using these data sets to predict performance of the core digital twin for unknown future state. Instead of providing specific physical properties for a container, the model is provided with a numeric value for each type of container added to Data Lake. This reduces dimension of the input vector and makes the model robust by allowing predicting future state for containers with limited knowledge.

Additional Embodiments. In at least one additional embodiment, the foregoing processes and components, especially the Digital Twin model, can be used in conjunction with historical data to retroactively review and analyze temperature, location and payload efficacy data records to estimate one or more root causes of potential failures or actual failures of the route and container to maintain the payload within the specified conditions.

In at least one additional embodiment, this historical analysis can be used to define future packaging (container) schemes and the related “pack-out” for particular payload amounts. By “pack-out”, we are referring to the exact method of placing the payload, which may be in several smaller containers (e.g., bags, vials, smaller boxes, etc.) and may be layered and/or surrounded by one or more energy absorbing elements (e.g., frozen gel packs, phase change packs, etc.).

In at least one additional embodiment, a control tower automation process will leverage the electronic communications and the predictive energy processes for containers in transit to notify appropriate stakeholders such as the shipper, receiver and/or logistics provider of potential excursion event.

In at least one additional embodiment, a control tower automation process will leverage the electronic communications and the predictive energy processes to notify appropriate stakeholders such as the shipper, receiver and/or logistics provider to take preventative actions, such as but not limited to hibernate (recharge), repack or re-route the container based on predicted future state of the shipment.

Computing Platform for Executing Logical Processes. The “hardware” portion of a computing platform typically includes one or more processors accompanied by, sometimes, specialized co-processors or accelerators, such as graphics accelerators, and by suitable computer readable memory devices (RAM, ROM, disk drives, removable memory cards, etc.). Depending on the computing platform, one or more network interfaces may be provided, as well as specialty interfaces for specific applications. If the computing platform is intended to interact with human users, it is provided with one or more user interface devices, such as display(s), keyboards, pointing devices, speakers, etc. And, each computing platform requires one or more power supplies (battery, AC mains, solar, etc.).

Terminology and Equivalent Components, Steps and Elements. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Certain embodiments utilizing a microprocessor executing a logical process may also be realized through customized electronic circuitry performing the same logical process(es). The foregoing example embodiments do not define the extent or scope of the present invention, but instead are provided as illustrations of how to make and use at least one embodiment of the invention.

What is claimed is:

1. A method implemented on a computing device to track and predict a condition of a payload and a container conveying the payload in shipment, the method comprising:
receiving, by a remote server, from a wireless tracking module, monitoring data including at least one or both conditions of a shipping container and an environment around the container, wherein the wireless tracking module is associated with the container;
calculating, by a remote server, a current energy state of the payload and the container;
predicting, by a remote server, one or more future energy states of the payload and container based on an estimated time of shipment completion and one or more prescribed condition thresholds corresponding to a type of the payload, container type and the shipping route;
determining, by a remote server, an impending violation of a payload handling requirement according to the one or more future energy states;
determining, by a remote server, at least one intervention action to prevent the impending violation which, when implemented to the container, or the shipping route, or to both the container and the shipping route, avoids the predicted violation; and
transmitting, by a remote server, a notification of the predicted impending violation and the at least one intervention action.

2. The method as set forth in claim 1 wherein the at least one expected shipping route condition comprises a shipping route condition selected from the group consisting of an external environmental condition, an operational condition, and a handling condition.

3. The method as set forth in claim 1 wherein the one or more conditions of the container, or the environment around the container or both, comprises a condition selected from the group consisting of temperature measurement, humidity measurement, pressure measurement, physical shock measurement and light measurement.

4. The method as set forth in claim 1 wherein the predicting, by a remote server, of one or more future energy states of the payload and container comprises developing, by a remote server, a digital twin model of the payload and the container, and applying one or more mathematical correlations of physical models, empirical models, or both physical and empirical models for which one or more future energy states of the digital twin are determined based on the estimated time of shipment completion and one or more prescribed condition thresholds corresponding to a type of the payload, container type and the shipping route, and for which the at least one intervention action is validated to avoid the predicted impending violation.

5. The method as set forth in claim 1 wherein the transmitting a notification of the predicted impending violation and the at least one intervention action comprises transmitting the notification to a control tower process operated by one or more stakeholders selected from the group consisting of a shipper party, a receiver party, and a logistics management party.

6. The method as set forth in claim 1 wherein the transmitted at least one intervention action comprises at least one interventional action selected from the group consisting of hibernating the container, recharging the container, repacking the container, and re-routing the container.

7. A method implemented on a computing device to improve conveying a payload in a container during shipment, comprising:
accessing, by a remote server, historical data collected from one or more monitoring data including at least one or both conditions of one or more containers and an environment around the one or more containers during shipment, wherein the monitoring data was collected by a wireless tracking module associated with each container;
developing, by a remote server, at least one digital twin model of one or more of the payloads and one or more of the containers, by applying one or more mathematical correlations of physical models, empirical models, or both physical and empirical models for which one or more past energy states of the digital twin are determined based on an estimated time of shipment completion and one or more prescribed condition thresholds corresponding to a type of the payload, container type and the shipping route;
estimating, by a remote server, one or more likely root causes of failures during shipment to maintain the payload within the prescribed condition thresholds; and
transmitting, by a remote server, the one or more estimated likely root causes.

8. The method as set forth in claim 7 wherein at least one estimated likely root cause of failure includes a shipping route condition selected from the group consisting of an external environmental condition, an operational condition, and a handling condition.

9. The method as set forth in claim 7 wherein one or more conditions of the container, or the environment around the container, or both, of the monitoring data comprises a condition selected from the group consisting of temperature measurement, humidity measurement, pressure measurement, physical shock measurement and light measurement.

10. A method implemented on a computing device to improve conveying a payload in a container during shipment, comprising:
accessing, by a remote server, historical data collected from one or more monitoring data including at least one or both conditions of one or more containers and an environment around the one or more containers during shipment, wherein the monitoring data was collected by a wireless tracking module associated with each container;
developing, by a remote server, at least one digital twin model of one or more of the payloads and one or more of the containers, by applying one or more mathematical correlations of physical models, empirical models, or both physical and empirical models for which one or more past energy states of the digital twin are determined based on an estimated time of shipment completion and one or more prescribed condition thresholds corresponding to a type of the payload, container type and the shipping route;
estimating, by a remote server, one or more preemptive actions to prevent future violations of the prescribed condition thresholds during future shipments; and
transmitting, by a remote server, the one or more estimated preemptive actions.

11. The method as set forth in claim 10 wherein one or more preemptive actions comprise at least one preemptive action selected from the group consisting of a change in packaging for the container, a change in the pack-out for the container, a change in the payload amount for the container, and a change in a shipping lane used for the shipment.

12. The method as set forth in claim 10 wherein one or more conditions of the container, or the environment around the container, or both, of the monitoring data comprises a condition selected from the group consisting of temperature measurement, humidity measurement, pressure measurement, physical shock measurement and light measurement.
